(19) United States
(12) Patent Application Publication
(10) Pub. No.: US 2022/0201996 A1
(43) Pub. Date: Jun. 30, 2022

(54) Universal Connector

(71) Applicant: Texas Customs, Inc., Sachse, TX (US)

(72) Inventors: Jeffrey Leonard Slusher, Sachse, TX (US); Fernando Cristan, Rowlett, TX (US)

(21) Appl. No.: 17/225,154

(22) Filed: Apr. 8, 2021

Related U.S. Application Data
(63) Continuation-in-part of application No. 17/138,921, filed on Dec. 31, 2020.

(51) Int. Cl. A01K 75/00; F16B 45/02; F16B 45/00

(52) U.S. Cl. CPC A01K 75/00; F16B 45/008; F16B 45/036

(57) ABSTRACT

The invention discloses a universal connector, a method of making it, and a method of using it, by example. In a first embodiment, a universal connector is disclosed comprising an improved carabiner that incorporates a magnet into its structure. The carabiner magnet has a force of attraction of at least 2 kilograms to enable it to connect to any magnetic material. A second of many possible embodiments discloses the addition of hook and loop tape (i.e. a Velcro® strip) to enable the universal connector to connect to any other article having hook and loop tape. A third possible embodiment discloses the addition of a loop for connection to any strap or keychain, for example. A fourth contemplated embodiment discloses the addition of male and/or female snaps.

### CROSS REFERENCE TO RELATED APPLICATIONS

This application is a continuation-in-part of U.S. patent application Ser. No. 17/138,921 and claims priority to U.S. patent application Ser. No. 17/138,921, filed Dec. 31, 2020. The entire contents of U.S. patent application Ser. No. 17/138,921 is incorporated herein by reference.

### BACKGROUND OF THE INVENTION

Carabiner clip connectors having magnetic materials incorporated into the structure are well known in the art as are carabiner loops for receiving vinyl strips that may have Velcro®, snaps, or a keychain on the other end for connection to other articles.

The widespread use of Velcro® existent on thousands of different articles of manufacture necessitates a new approach of the carabiner clip to incorporate this functionality in a monolithic universal connector that is light and useful for connecting things.

The widespread use of snap fasteners existent on thousands of different articles of manufacture necessitates a new approach of the carabiner clip to incorporate this functionality in a monolithic universal connector that is light and useful for connecting things.

### SUMMARY OF THE INVENTION

In a first embodiment, a universal connector is disclosed comprising an improved carabiner that incorporates a magnet monolithically into the structure of a housing enclosure. The carabiner magnet has a force of attraction of at least 2 kilograms to enable it to connect to any magnetic material. A second of many possible embodiments discloses the addition of hook and loop tape (i.e. a Velcro® strip) to enable the universal connector to connect to any other article having hook and loop tape. A third possible embodiment discloses the addition of a loop for connection to any strap or keychain, for example. A fourth possible embodiment discloses the further addition of at least one male snap fastener and/or at least one female snap fastener to the housing of the invention.

### ADVANTAGES OF THE INVENTION

The many objects and advantages of the present invention will become apparent to those skilled in the art by examples of various preferred embodiments. They should be reviewed along with the attached drawings wherein like reference numerals refer to like components throughout. The variously described embodiments of the present invention have many advantages, but the invention is not limited by only the embodiments described herein. Although the present invention will be described in considerable detail with reference to certain preferred embodiments thereof, other alternative embodiments are possible. Therefore, the spirit and scope of the claims should not be limited to the description of the preferred embodiments, nor the alternative embodiments, and examples contained herein.

The improved carabiner of the invention is the first in the fastener art to contain a magnet fully or partially enclosed within its structure. The invention relates to a new universal connector comprising at least one improved carabiner having a housing with the top being the hook and clip part. The bottom may have a loop which exists on conventional carabiners for a strap or keychain (the strap being connected at the other end with either a snap, or hook and loop tape called Velcro®). One purpose of the present invention is to remove the necessity of having a strap attached to the conventional carabiner clip, but, instead, conjoin one or more variously sized snaps (male and/or female) or Velcro® strips directly onto the monolithic structure of the new carabiner having a magnet with at least two kilograms strength fully or partially enclosed within its housing.

The invention is not limited to using only Velcro®. Various embodiment are contemplated where any kind of adhesive or tape could be used. Additionally, any side of the universal connector can house a male or female snap fastener. The second side in various embodiments may only expose the housing enclosure fully or partially covering the magnet inside.

By way of example, one skilled in the art can see the primary advantage of the present invention, since a single universal connector can be used equivalently with a fishing net having a magnetic clasp system that holds the net by magnetic attraction connected to the net as a medallion, thusly magnetically keeping the net adjacent the pole while scooping up a fish; or with a fishing net having a Velcro® clasp system of similar functionality; or a fishing net having a snap fastener clasp system, in similar manner.

To ensure antecedent basis for all types of claims in the specification, this application recites the original claims herein as follows:

1. A universal connector comprising at least one carabiner having a housing with a top, a bottom, a first side, and a second side; said housing further comprising a magnet enclosed within.
2. The universal connector of claim 1, further comprising hook and loop tape affixed to the first side of said housing.
3. The universal connector of claim 1, further comprising a loop at the bottom of said housing.
4. The universal connector of claim 2, further comprising a loop at the bottom of said housing.
5. The universal connector of claim 1, wherein said magnet has at least two kilograms strength.
6. The universal connector of claim 2, wherein said magnet has at least two kilograms strength.
7. The universal connector of claim 3, wherein said magnet has at least two kilograms strength.
8. The universal connector of claim 4, wherein said magnet has at least two kilograms strength.
9. The universal connector of claim 1, further comprising at least one male fastener and at least one female fastener monolithic with the housing.
10. The universal connector of claim 2, further comprising at least one male fastener and at least one female fastener monolithic with the housing.
11. The universal connector of claim 3, further comprising at least one male fastener and at least one female fastener monolithic with the housing.
12. The universal connector of claim 4, further comprising at least one male fastener and at least one female fastener monolithic with the housing.
13. The universal connector of claim 5, further comprising at least one male fastener and at least one female fastener monolithic with the housing.
14. The universal connector of claim 6, further comprising at least one male fastener and at least one female fastener monolithic with the housing.
15. The universal connector of claim 7, further comprising at least one male fastener and at least one female fastener monolithic with the housing.
16. The universal connector of claim 8, further comprising at least one male fastener and at least one female fastener monolithic with the housing.
17. A method of making a universal connector, comprising the steps of:
a. loading a magnet into a cavity of a carabiner mold;
b. closing the mold;
c. injecting a plastic into the mold;
d. allowing said plastic to cure;
e. removing the universal connector from the mold.
18. The method of making the universal connector of claim 17, further comprising the step of adding a strip of hook and loop tape to a side of the housing.
19. The method of making the universal connector of claim 17, further comprising the step of adding a at least one male fastener and at least one female fastener to a side of the housing.
20. The method of making the universal connector of claim 18, further comprising the step of adding a at least one male fastener and at least one female fastener to a side of the housing.
21. A method of using a universal connector comprising clipping said universal connector to a fishing net having a magnetic clasp system, said universal connector comprising at least one carabiner having a housing with a top, a bottom, a first side, and a second side; said housing further comprising a magnet enclosed within.
22. The method of using the universal connector of claim 21, wherein said universal connector further comprises hook and loop tape affixed to the first side of said housing.
23. The method of using the universal connector of claim 21, wherein said universal connector further comprises a loop at the bottom of said housing.
24. The method of using the universal connector of claim 21, wherein said universal connector further comprises at least one male snap fastener and at least one female snap fastener monolithic with the housing.
25. The method of using the universal connector of claim 22, wherein said universal connector further comprises a loop at the bottom of said housing.
26. The method of using the universal connector of claim 21, wherein said magnet has at least two kilograms strength.
27. The method of using the universal connector of claim 22, wherein said magnet has at least two kilograms strength.
28. The method of using the universal connector of claim 23, wherein said magnet has at least two kilograms strength.
29. The method of using the universal connector of claim 24, wherein said magnet has at least two kilograms strength.
30. The method of using the universal connector of claim 25, wherein said magnet has at least two kilograms strength.
31. The method of using the universal connector of claim 21, wherein said fishing net has a hook and loop tape clasp system.
32. The method of using the universal connector of claim 29, wherein said universal connector further comprises a loop at the bottom of said housing.
33. The method of using the universal connector of claim 21, wherein said fishing net has a snap fastener clasp system.

### BRIEF DESCRIPTION OF THE DRAWINGS

FIG. 1 is a perspective view of an exemplary embodiment of a universal connector showing a first side 010 with only a magnet inside its housing.

FIG. 2 is a perspective view of an exemplary embodiment of a universal connector showing a second side 020 with only hook and loop tape affixed outside the universal connector housing.

FIG. 3 is a perspective view of an exemplary embodiment of a universal connector with a loop 030 incorporated into the bottom structure of its housing.

FIG. 4 is a perspective view of an exemplary embodiment of a universal connector with a male snap 030 incorporated into a side of its housing.

FIG. 5 is a perspective view of an exemplary embodiment of a universal connector with a female snap 020 incorporated into a side of its housing.

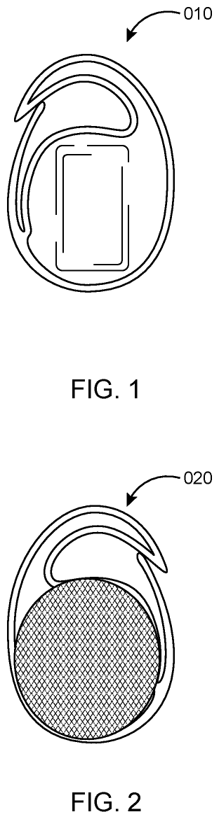

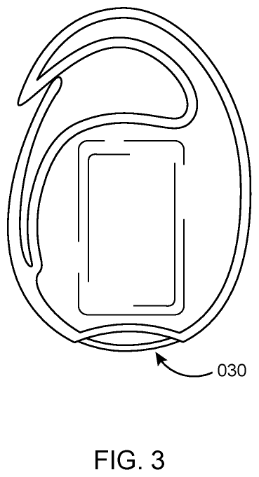

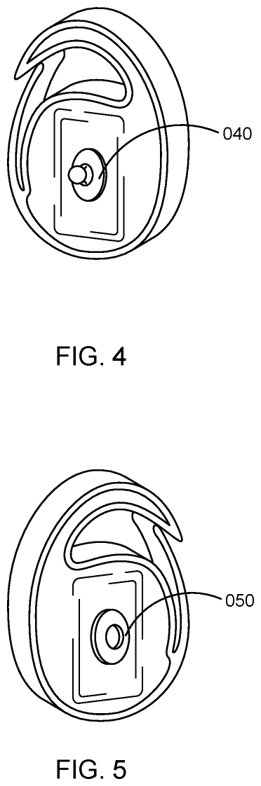

### DETAILED DESCRIPTION OF SOME PREFERRED EMBODIMENTS

The present invention relates to a new universal connector comprising at least one improved carabiner having a housing with the top being the hook and clip part. The bottom may have a loop 030 which exists on conventional carabiners for a strap or keychain (the strap being connected at the other end with either a snap or hook and loop tape called Velcro®). A stated purpose of the invention is to remove the necessity of having a conventional strap attached to a carabiner clip, and, instead, conjoin one or more sized snap(s) (male 040 and/or female 050) or Velcro® 020 directly onto the monolithic structure of the new and improved carabiner having a magnet 010 with at least two kilograms strength fully or partially enclosed within its housing. It is contemplated that any side of the universal connector can house at least one male 040 and/or female 050 snap fastener of various sizes. The second side in various embodiments may only expose the plastic enclosure fully or partially covering the magnet 010 inside.

The foregoing detailed description is to be clearly understood as given by way of illustration and example only, the spirit and the scope of this invention being limited solely by the claims.

What is claimed is:

1. A universal connector comprising at least one carabiner having a housing with a top, a bottom, a first side, and a second side; said housing further comprising a magnet enclosed within.

2. The universal connector of claim 1, further comprising hook and loop tape affixed to the first side of said housing.

3. The universal connector of claim 1, further comprising a loop at the bottom of said housing.

4. The universal connector of claim 2, further comprising a loop at the bottom of said housing.

5. The universal connector of claim 1, wherein said magnet has at least two kilograms strength.

6. The universal connector of claim 2, wherein said magnet has at least two kilograms strength.

7. The universal connector of claim 3, wherein said magnet has at least two kilograms strength.

8. The universal connector of claim 4, wherein said magnet has at least two kilograms strength.

9. The universal connector of claim 1, further comprising at least one male fastener and at least one female fastener monolithic with the housing.

10. The universal connector of claim 2, further comprising at least one male fastener and at least one female fastener monolithic with the housing.

11. The universal connector of claim 3, further comprising at least one male fastener and at least one female fastener monolithic with the housing.

12. The universal connector of claim 4, further comprising at least one male fastener and at least one female fastener monolithic with the housing.

13. The universal connector of claim 5, further comprising at least one male fastener and at least one female fastener monolithic with the housing.

14. The universal connector of claim 6, further comprising at least one male fastener and at least one female fastener monolithic with the housing.

15. The universal connector of claim 7, further comprising at least one male fastener and at least one female fastener monolithic with the housing.

16. The universal connector of claim 8, further comprising at least one male fastener and at least one female fastener monolithic with the housing.

17. A method of making a universal connector, comprising the steps of:
a. loading a magnet into a cavity of a carabiner mold;
b. closing the mold;
c. injecting a plastic into the mold;
d. allowing said plastic to cure;
e. removing the universal connector from the mold.

18. The method of making the universal connector of claim 17, further comprising the step of adding a strip of hook and loop tape to a side of the housing.

19. The method of making the universal connector of claim 17, further comprising the step of adding a at least one male fastener and at least one female fastener to a side of the housing.

20. The method of making the universal connector of claim 18, further comprising the step of adding a at least one male fastener and at least one female fastener to a side of the housing.

21. A method of using a universal connector comprising clipping said universal connector to a fishing net having a magnetic clasp system, said universal connector comprising at least one carabiner having a housing with a top, a bottom, a first side, and a second side; said housing further comprising a magnet enclosed within.

22. The method of using the universal connector of claim 21, wherein said universal connector further comprises hook and loop tape affixed to the first side of said housing.

23. The method of using the universal connector of claim 21, wherein said universal connector further comprises a loop at the bottom of said housing.

24. The method of using the universal connector of claim 21, wherein said universal connector further comprises at least one male snap fastener and at least one female snap fastener monolithic with the housing.

25. The method of using the universal connector of claim 22, wherein said universal connector further comprises a loop at the bottom of said housing.

26. The method of using the universal connector of claim 21, wherein said magnet has at least two kilograms strength.

27. The method of using the universal connector of claim 22, wherein said magnet has at least two kilograms strength.

28. The method of using the universal connector of claim 23, wherein said magnet has at least two kilograms strength.

29. The method of using the universal connector of claim 24, wherein said magnet has at least two kilograms strength.

30. The method of using the universal connector of claim 25, wherein said magnet has at least two kilograms strength.

31. The method of using the universal connector of claim 21, wherein said fishing net has a hook and loop tape clasp system.

32. The method of using the universal connector of claim 29, wherein said universal connector further comprises a loop at the bottom of said housing.

33. The method of using the universal connector of claim 21, wherein said fishing net has a snap fastener clasp system.
